(19) United States
(12) Patent Application Publication
(10) Pub. No.: US 2002/0116861 A1
(43) Pub. Date: Aug. 29, 2002

(54) Fish hook and fly protector/container

(76) Inventor: Mary Lou Stockdale, Roseville, CA (US)

Correspondence Address: Mary Lou Stockdale, 547 Patton Drive, Roseville, CA, 95747, US

(21) Appl. No.: 09/792,317

(22) Filed: Feb. 23, 2001

(51) Int. Cl. A01K 87/00

(52) U.S. Cl. 43/25.2

(57) ABSTRACT

This invention has the novelty of being able to protect and contain fishing flies, fishing hooks, and baits while fishing rods are being moved from one location to the other. An additional novelty of this invention is that it prevents the fishing hooks and flies from being caught on tree branches, persons, clothing, and other areas while fishing rods are being moved from one location to the other. The invention can made manufactured from any type of plastic, metal or other appropriate material of construction and can be either temporarily or permanently affixed to the fishing rod.

### BACKGROUND OF THE INVENTION

One of the hazards of fishing is the potential of fishing hooks to be caught in a person's hair, skin, or other parts of the body as well as being caught on clothing, tree branches, and other objects while fishing rods are being moved from one location to the other. The use of this invention not only protects persons from being caught by fishing hooks, but it also protects fragile fishing flies as well as other types of baits while fishing rods are moved from one location to another. The invention acts not only as a protector for persons but also as a protector for the fishing fly, hook, and bait as well as a means to contain the fishing fly, hook, and bait in a convenient and safe location.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO A MICROFICHE APPENDIX

“Not Applicable”

### BACKGROUND OF THE INVENTION

One of the hazards of fishing is the potential of fishing hooks to be caught in a person's hair, skin, or other parts of the body as well as being caught on clothing, tree branches, and other objects while fishing rods are being moved from one location to the other. In addition, the invention acts not only as a protector for the fishing fly, hook, and bait; but, also acts as a means to contain the fishing fly, hook, and bait in a convenient and safe location. The use of this invention not only protects persons from being caught by fishing hooks, but it also protects fragile fishing flies as well as other types of baits while fishing rods are moved from one location to the other.

### BRIEF SUMMARY OF THE INVENTION

This invention solves the problem of the fishing hooks and flies being caught on objects, clothing, persons, etc. while the fishing rods are being moved from one location to the other. The fragile fishing flies are also protected with the use of this convention and the fishing hook, fly, and bait is contained in one convenient location as well. This invention can be snapped, clamped, or attached in any convenient way to the fishing rod as well as be permanently affixed to the fishing rod.

### BRIEF DESCRIPTION OF THE SEVERAL VIEWS OF THE DRAWING

FIG. 1: An inside view of the invention in use.

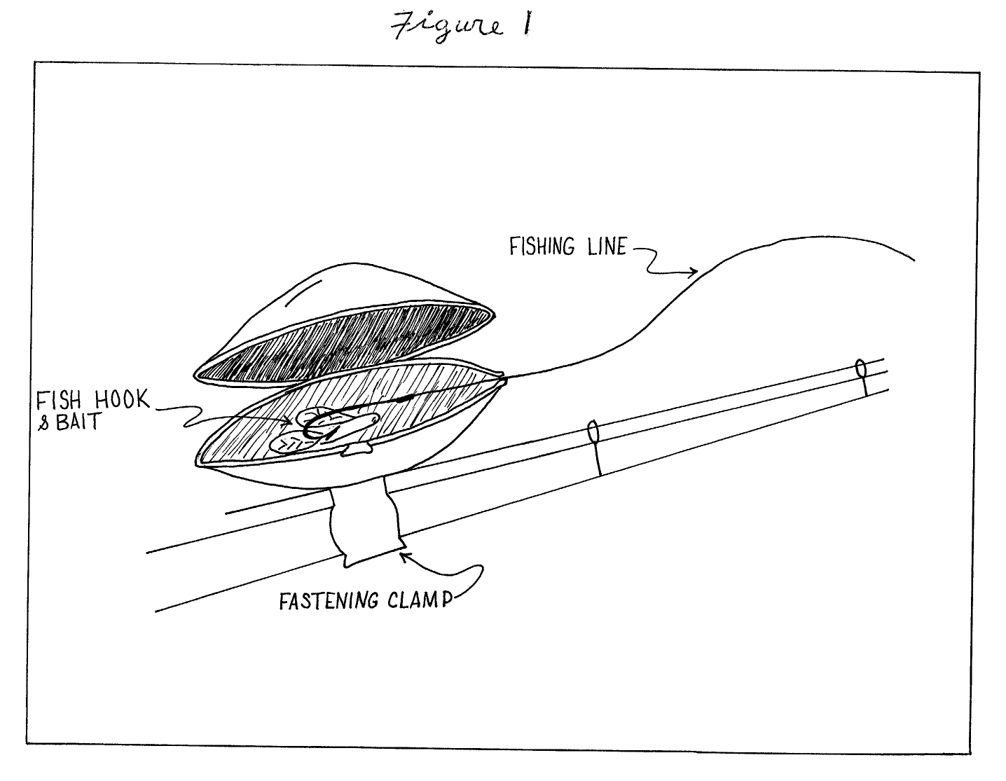

FIG. 2: An outside view of the invention in use.

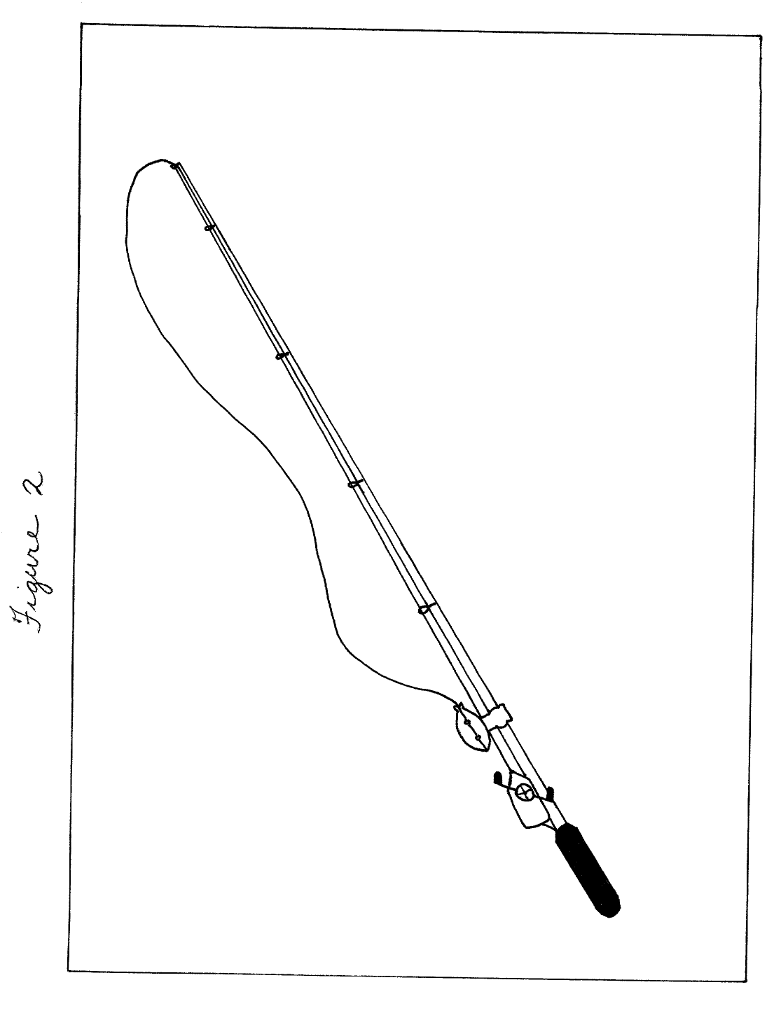

### DETAILED DESCRIPTION OF THE INVENTION

The invention acts not only as a protector for the fishing fly, hook, and bait; but, also acts as a means to contain the fishing fly, hook, and bait in a convenient and safe location. The use of this invention not only protects persons from being caught by fishing hooks or fishing hooks from being caught on branches, shrubbery, etc., but it also protects fragile fishing flies as well as other types of baits while fishing rods are moved from one location to the next. The “Fish Hook and Fly Protector/Container” can be made of a wide variety of types of plastics, metals, rubbers, and any other appropriate materials of construction. The invention is comprised of a snap that opens and closes around the fishing fly, hook, and bait. Lastly, the invention can be made as a separate piece of equipment that clamps or snaps onto the fishing rod or it can be permanently affixed to the fishing rod as well.

1. I claim that this invention protects the fly, fishing hook, and bait.

2. I claim that this invention contains/encloses the fishing fly, fishing hook, and bait.

3. I claim that this invention prevents the fishing fly, fishing hook, and bait from being caught on tree branches, clothing, persons, or other areas while fishing poles are moved from one location to the other.

4. I claim that this invention can be made as a separate piece of equipment that snaps, clamps, or is otherwise temporarily attached to the fishing rod. This invention can be manufactured from different types of plastics, metals, or any other appropriate materials of construction.

5. I claim that this invention can be permanently affixed to the fishing rod.
